(19) United States
(12) Patent Application Publication
(10) Pub. No.: US 2017/0251407 A1
(43) Pub. Date: Aug. 31, 2017

(54) METHOD AND APPARATUS FOR SENDING HANDOVER INDICATION TO ASSISTING CELL

(71) Applicant: NOKIA SOLUTIONS AND NETWORKS OY, Espoo (FI)

(72) Inventors: Alexander SAYENKO, Espoo (FI); Karri Markus RANTA-AHO, Espoo (FI)

(21) Appl. No.: 15/504,935

(22) PCT Filed: Aug. 18, 2014
(86) PCT No.: PCT/EP2014/067562

§ 371 Date: Feb. 17, 2017

(51) Int. Cl. H04W 36/00

(52) U.S. Cl. CPC H04W 36/0027

(57) ABSTRACT

A method comprises determining that a handover of a user equipment in multi-flow communication with a serving cell and an assisting cell has taken place and providing, from a radio network controller to a first access point providing the assisting cell, an indication of the handover.

### FIELD OF INVENTION

Some embodiments relate to a method and apparatus for use in a system in which a user equipment may be arranged to receive data from two or more cells.

### BACKGROUND

A communication system may be seen as a facility that enables communication sessions between two or more nodes such as fixed or mobile communication devices, access points such as nodes, base stations, servers, hosts, machine type servers, routers, and so on. A communication system and compatible communicating devices typically operate in accordance with a given standard or specification which sets out what the various entities associated with the system are permitted to do and how that should be achieved. For example, the standards, specifications and related protocols may define the manner how communication devices shall communicate with the access points, how various aspects of the communications shall be implemented and how the devices and functionalities thereof shall be configured.

An example of cellular communication systems is an architecture that is being standardized by the 3rd Generation Partnership Project (3GPP). A recent development in this field is often referred to as the long-term evolution (LTE) or long-term evolution advanced (LTE advanced) of the Universal Mobile Telecommunications System (UMTS) radio-access technology. In LTE base stations providing the cells are commonly referred to as enhanced NodeBs (eNB). An eNB may provide coverage for an entire cell or similar radio service area.

A user may access the communication system by means of an appropriate communication device. A communication device of a user is often referred to as user device (UE), user device or terminal. A communication device is provided with an appropriate signal receiving and transmitting arrangement for enabling communications with other parties. In wireless systems a communication device typically provides a transceiver station that may communicate with another communication device such as e.g. a base station. A communication device such as a user device (UE) may access a carrier provided by a base station, and transmit and/or receive on the carrier.

A mobile communication network may logically be divided into a radio access network (RAN) and a core network (CN). The core network entities typically include various control or management entities, and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN), the GSM/EDGE radio access network (GERAN) and the evolved UMTS terrestrial radio access network (EUTRAN).

A geographical area covered by a radio access network is divided into cells defining a radio coverage provided by a transceiver network element or access point, such as a NodeB, eNodeB and/or base transceiver station. A single transceiver network element may serve a number of cells. A plurality of transceiver network elements is typically connected to a controller network element, such as a radio network controller (RNC) or other management entity.

A user device may be mobile and may move from one geographical area to another, in this case a handover between a source eNode B to a target eNode B may be carried to support a user device that has moved. In order to support user devices on the coverage edge of cells, multi-flow may be introduced where data is transmitted to the user device by both of the cells. The user device may receive both data transmissions and reorder the data into one data stream. Multi-flow operations may be affected by the handover of the user device from a serving node to a target node.

According to an aspect, there is provided a method comprising: determining that a handover of a user equipment in multi-flow communication with a serving cell and an assisting cell has taken place; and providing, from a radio network controller to a first access point providing the assisting cell, an indication of the handover.

The radio network controller may receive an indication of the handover from a radio network controller of an access point supporting the serving cell.

The radio network controller may support the first access point and a second access point providing the serving cell.

The determination may be based on the radio network controller carrying out a handover procedure for the user equipment.

According to another aspect, there is provided a method comprising: providing an assisting cell in a multi-flow communication with a user equipment; receiving, from a radio network controller, an indication of a handover of the user equipment in communication with a serving cell and the assisting cell; and updating a carrier activation status of the assisting cell.

The carrier activation status may be updated to active.

The carrier activation status may be updated to be aligned with a carrier activation status of the user equipment.

The method may be performed in an access node.

According to another aspect, there is provided an apparatus in a radio network controller comprising: means for determining that a handover of a user equipment in multi-flow communication with a serving cell and an assisting cell has taken place; and providing, to a first access point providing the assisting cell, an indication of the handover.

The apparatus may receive an indication of the handover from a radio network controller of an access point supporting the serving cell.

The apparatus may support the first access point and a second access point providing the serving cell.

The means for determining may determine that the handover has taken place in dependence on the radio network controller carrying out a handover procedure for the user equipment.

According to another aspect, there is provided an apparatus comprising: means for providing an assisting cell in a multi-flow communication with a user equipment; means for receiving, from a radio network controller, an indication of a handover of the user equipment in communication with a serving cell and the assisting cell; and means for updating a carrier activation status of the assisting cell.

The carrier activation status may be updated to active.

The carrier activation status may be updated to be aligned with a carrier activation status of the user equipment.

According to another aspect, there is provided an apparatus for use in a radio network controller, said apparatus comprising at least one processor and at least one memory including computer code for one or more programs, the at least one memory and the computer code configured, with the at least one processor, to cause the apparatus at least to: determine that a handover of a user equipment in multi-flow communication with a serving cell and an assisting cell has taken place; and provide, to a first access point providing the assisting cell, an indication of the handover.

The radio network controller may receive an indication of the handover from a radio network controller of an access point supporting the serving cell.

The radio network controller may support the first access point and a second access point providing the serving cell.

The determination may be based on the radio network controller carrying out a handover procedure for the user equipment.

According to another aspect, there is provided an apparatus, said apparatus comprising at least one processor and at least one memory including computer code for one or more programs, the at least one memory and the computer code configured, with the at least one processor, to cause the apparatus at least to: provide an assisting cell in a multi-flow communication with a user equipment;

receive, from a radio network controller, an indication of a handover of the user equipment in communication with a serving cell and the assisting cell; and update a carrier activation status of the assisting cell.

The carrier activation status may be updated to active.

The carrier activation status may be updated to be aligned with a carrier activation status of the user equipment.

The apparatus may be provided in an access node.

One or more of the following may be used with any one or more of the above aspects.

The handover may be such that the serving cell of said user equipment is changed.

The handover may be between the serving cell and a target cell.

The indication may form part of an information element.

The information element may comprise at least one of multi-flow configuration information and configuration information.

The indication may alternatively be provided in a stand-alone message or as part of any other suitable message.

The indication may be a Boolean value.

The indication may include an indication of at least one of the target cell and the serving cell.

A computer program comprising program code means adapted to perform the herein described methods may also be provided. In accordance with further embodiments apparatus and/or computer program product that can be embodied on a computer readable medium for providing at least one of the above methods is provided.

It should be appreciated that any feature of any aspect may be combined with any other feature of any other aspect.

### BRIEF DESCRIPTION OF DRAWINGS

Embodiments will now be described in further detail, by way of example only, with reference to the following examples and accompanying drawings, in which:

FIG. 1 is a schematic diagram showing an example of a network in which embodiments may be implemented;

FIG. 2 is a schematic diagram showing a user equipment according to some embodiments;

FIG. 3 is a schematic diagram showing a control apparatus according to some embodiment;

FIGS. 4a and 4a are schematic diagrams showings a multi-flow in accordance with some embodiments in operation with one and two radio network controllers respectively;

FIGS. 5a and 5b are flow diagram depicting the method steps carried out by a radio network controller and user equipment respectively in accordance with some embodiments;

FIG. 6 schematically shows an arrangement with three access nodes, each supporting two cells and a user equipment;

FIG. 7 shows a first signal flow; and

FIG. 8 shows a second signal flow.

### DETAILED DESCRIPTION

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features/structures that have not been specifically mentioned.

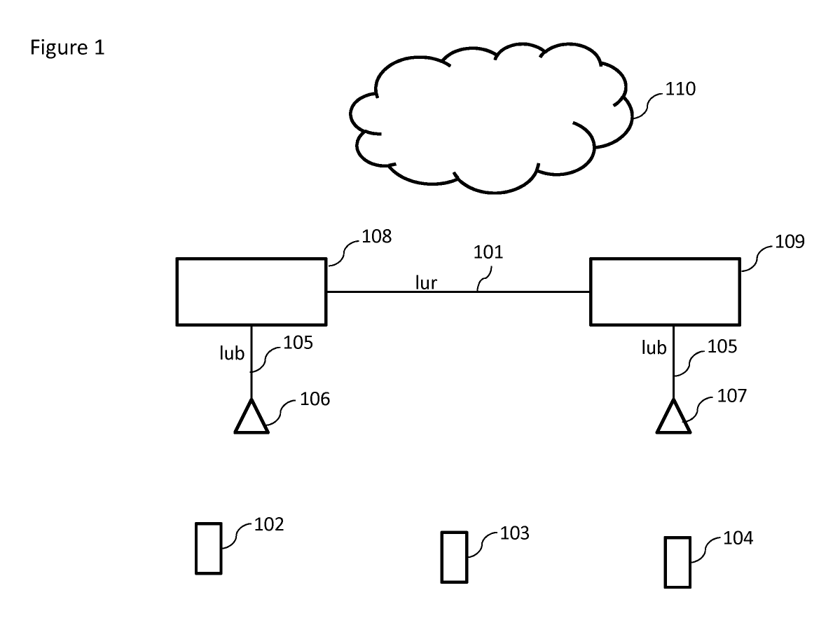

Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipment (UE) 102, 103, 104 are provided wireless access via at least one network access point. The network access point may be for example a base station, base transceiver station, node B, enhanced node B, access node or similar wireless transmitting and/or receiving node or point. Access points are typically controlled by at least one appropriate controller apparatus, so as to enable operation thereof and management of mobile communication devices in communication with the access points. The controller apparatus may be part of the access point and/or provided by a separate entity such as a Radio Network Controller.

In FIG. 1 control apparatus 108 and 109 are shown to control the respective access points 106 and 107. The control apparatus of an access point can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of separate RNCs; rather the node B is enhanced to include the radio network controller functionality and in this sense the radio network controller forms part of an eNB. The eNB may be in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 the access points 106 and 107 may be connected to a wider communications network or core network 110 via respective radio network controllers 108 and 109. The access points may additionally be connected to the core network 110 via gateways (not shown).

In the example of FIG. 1 there may be an interface between the radio network controllers 108 and 109 shown at 101. This interface may be a lur interface. There may be an interface between the radio network controllers 108 and 109 and their respective access points 106 and 107 shown at 105. This may be a lub interface. It will be appreciated that in some cases, a radio network controller may support more than one access node. For example, the radio network controllers 108 and 109 may be one entity in some cases.

Each access point 106 and 107 of FIG. 1 may support a number of cells which may be used to communicate with a user equipment. In some implementations a user equipment may be in communication with more than one cell at the same frequency at a time. In the example of multi-flow, a user equipment may receive data transmissions from two or more cells residing at the same frequency and reorder the received packets to reform a data stream. The cells involved in the multi-flow transmissions may be provided by a single access point or more than one access point.

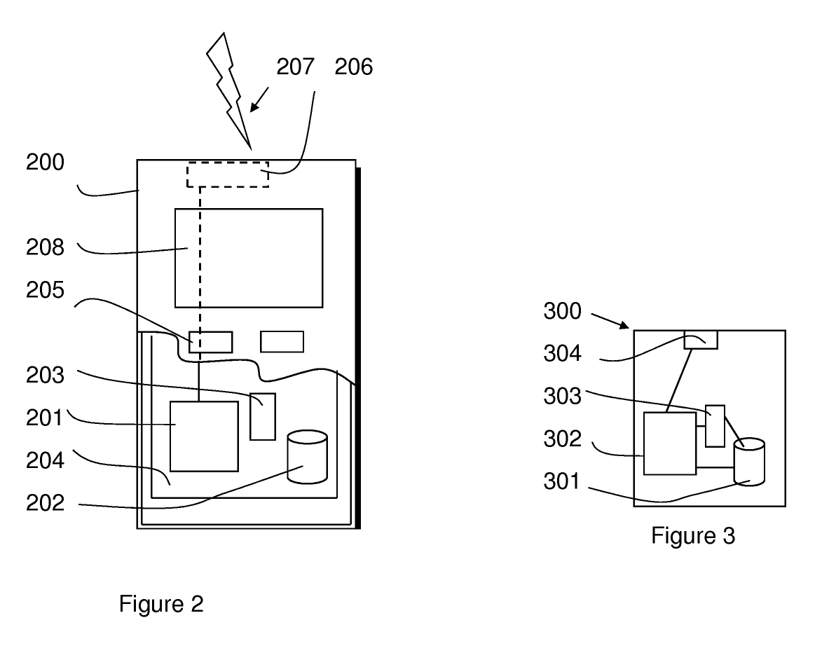

The user equipment 101, 102 and 103 of FIG. 1 may be any suitable communication device. Possible communication device will now be described in more detail with reference to FIG. 2 showing a schematic, partially sectioned view of a communication device 102. Such a communication device is often referred to as user equipment (UE) or terminal. An appropriate communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like.

A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The device 102 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the device.

A device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the device by means of a suitable user interface such as key pad 205, voice commands, touch sensitive screen or pad, combinations thereof or the like. A display 208, a speaker and a microphone can be also provided. Furthermore, a communication device may comprise appropriate connectors (either wired or wireless) to other devices and/or for connecting external accessories, for example hands-free equipment, thereto.

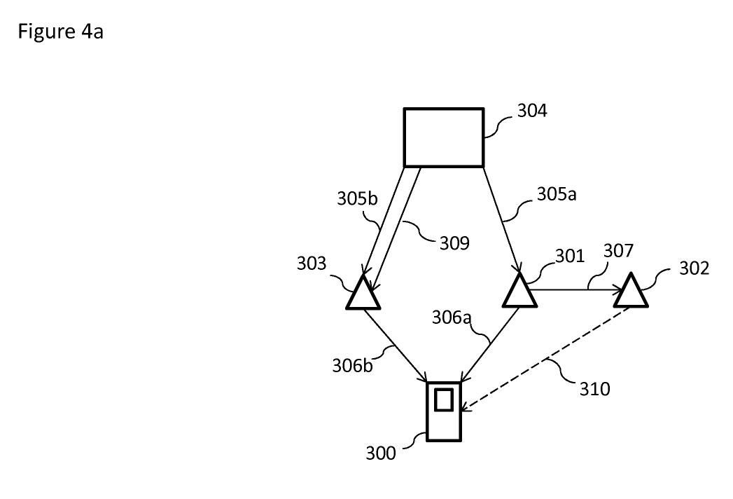

FIG. 3 shows an example of a control apparatus. The control apparatus comprises at least one memory 301, at least one data processing unit 302, 303 and an input/output interface 304. Via the interface the control apparatus can be coupled to receive and/or transmit data. For example the control apparatus can be configured to execute an appropriate software code to provide the control functions. The control apparatus may be provided in one or more of an access node and the radio network controller. It will be appreciated that a control apparatus forming a radio network controller may be configured to carry out the method steps associated with a radio network controller. It will also be appreciated that a control apparatus forming an access point may be configured to carry out the functionality and/or method steps associated with an access point.

The network of FIG. 1 may be capable of implementing multi-flow with regards to user equipment supported by the network. Multi-flow is implemented when transmissions to the user equipment are made from more than one cell operating at the same frequency. This may be of particular use when a user equipment is at a coverage edge of two cells, in which case the quality of service for the user equipment may be improved by the implementation of multi-flow. The user equipment may simultaneously receive data from more than one cell in multi-flow. Intra-access node multi-flow occurs when a user equipment receives data from two or more cells supported by a single access point. Inter-access node multi-flow occurs when a user equipment receives data transmissions by two or more cells supported by separate access points.

A user equipment in multi-flow communications may undergo a handover procedure. Handover occurs when a controlling node identifies a target access node and hands a user equipment over to the target access node so that the target access node become the new serving access node. Handover may occur when measurement reports from the user equipment indicate that a better service may be provided by the target access node, for example in a case where a user equipment is moving into the geographical area served by a cell of the target access node. Handover may also occur for example because the target access node may better support particular services required by the user equipment.

Each of the cells involved in the multi-flow may be transmitting to the user equipment using carriers that are configured when the multi-flow is set up. The transmitting cells may be a serving cell and an assisting cell. The user equipment may be aware of the carriers on which multi-flow communications are to be transmitted. In particular, certain carriers are activated for multi-flow communication and such communication takes place on these carriers.

Upon the handover operation, the controlling node provides a new configuration, whereupon the new configuration may instruct user equipment to continue with the multi-flow operation (e.g. a new cell from the serving access point and the same cell from the assisting access point) or even terminate the multi-flow operation if the assisting cells are not within the coverage.

When user equipment is configured with multi-flow operation, both the serving and assisting access point can de-activate a particular cell by means of a special lower layer (e.g. L1) order without involving a more complex higher layer re-configuration procedure. This procedure is used to perform fast de-activation of cells to save user equipment battery when data volumes are low, and activate them again when needed.

At handover or upon the serving cell change, the user equipment is served by a new access point. In this case the user equipment may forget or reset its carrier activation status since set of cells changed and therefore basis of activation status changed. In the case of intra access node multi-flow, the serving cell and the assisting cell are both supported by the same access node which is a serving access node. When the serving access node hands the user equipment over to the target access node, the serving access node may indicate to the assisting cell that handover has occurred. However, in the inter-access node multi-flow scenario, the assisting access point may be unaware of the serving cell change, which in turn may lead to carrier activation status misalignment between the user equipment and the assisting access point.

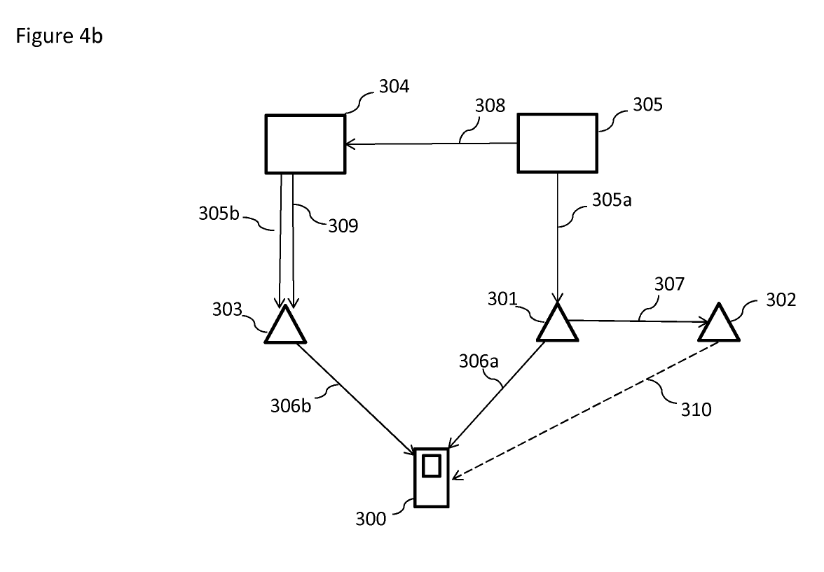

FIGS. 4a and 4b show two examples of a inter access point multi-flow. As described in some examples two access points may be supported by the same radio network controller and in some embodiment two access points may be supported by separate radio network controllers. FIG. 4a shows an example of multi-flow in the former and FIG. 4b the latter.

FIGS. 4a and 4b show a serving access node 301, a target access node 302, an assisting access node 303 and a user equipment 300. The serving access node 301 may support a serving cell for the user equipment 300 and the assisting access node may support an assisting cell for the user equipment 300. The user equipment may be in multi-flow communication with the network shown at 305a and b, and 306a and b, before being handed over, shown by 307, from the serving access node 301 to the target access node 302. After handover, the target access node 302 may transmit data to the user equipment 300 shown at 310. The assisting cell and serving cell may transmit multi-flow data to the user equipment 300 shown at 306b and 306a respectively. The multi-flow data may be received by the assisting cell and the serving cell from a (respective) radio network controller over an lub interface shown at 305b and 305a respectively.

FIG. 4a shows a case where the assisting access node 303 and the serving access node 301 are served by the same radio network controller 304. The radio network controller 304 may receive data to be transmitted to the user equipment 300 and provide it to the assisting access point 303 at 305b and the serving access point 301 at 305a. When handover occurs 307, the radio network controller 304 may provide an indication that handover has occurred to access point supporting the assisting cell 303. The access point 303 may thus be aware of the handover and may change a carrier activation status accordingly. The carrier activation status may be changed for example to be active. This may be done to align the carrier activation station with that of the user equipment that is handed over.

In the case of FIG. 4a, the radio network controller 304 is aware of the handover as it also supports the serving access point 301. The indication may be provided over an lub interface 309 between the radio network controller and the access point 303.

FIG. 4b shows a case where the serving access node 301 is supported by a first radio network controller 304 and the assisting access node 303 is supported by a second radio network controller 305. In this case, the first radio network controller 304 provides data for transmission to the serving access point 301 at 305a and the second radio network controller 305 provides data for transmission to the assisting access point 303 at 305b. The assisting cell may provide multi-flow data to the user equipment 300 at 306b and the serving cell may provide multi-flow data to the user equipment 300 at 306a.

When handover occurs 307, the second radio network controller 305 may provide an indication that handover has occurred to the access point supporting the assisting cell 303. The access point 303 may thus be aware of the handover and may change a carrier activation status accordingly. The carrier activation status may be changed for example to be active. This may be done to align the carrier activation station with that of the user equipment that is handed over.

In the case of FIG. 4b, the radio network controller 305 may not be immediately aware that handover has occurred. In this case, the first radio network controller 304 may provide an indication to the second radio network controller 304, indicating that handover has occurred. The indication between the radio network controllers may be provided over a lur interface 308 and the indication between the second radio network controller 304 and the assisting access node 303 may be provided over an lub interface 309.

The radio network controller serving the target access point 302 is not shown, it will be appreciated however that the target access point 302 may be served by a radio network controller of the assisting access point, serving access point or other radio network controller.

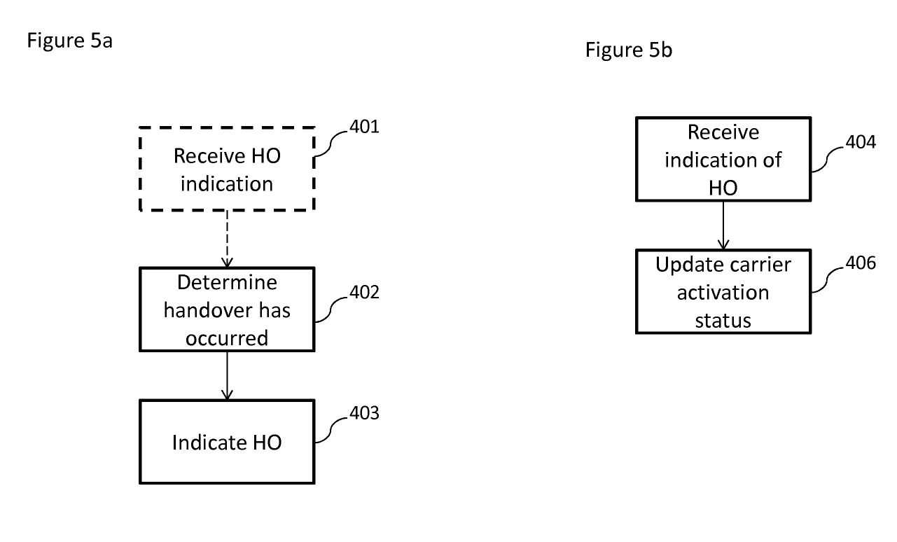

FIGS. 5a and 5b are flow diagrams depicting the method steps carried out by a radio network controller and an access node respectively according to some embodiments.

At step 402, a determination is made by the radio network controller that handover has occurred.

The determination may be made by the radio network controller supporting an access point that provides the assisting cell for multi-flow communication with a user equipment. In some embodiments, the radio network controller may also support the serving access point in which case the determination is based on an indication of a handover procedure from the serving access point to the radio network controller. In some embodiments, the determination may be based on an indication from a radio network controller of a serving access point to the radio network controller of the assisting access point. It will be appreciated that the reception of an indication of handover from another entity is shown at 401 which is an optional step.

The determination may comprise one or more of:

a handover command sent from serving RNC 305 towards UE, the serving access point detecting a layer 1 connection loss after forwarding a handover command to the UE,

a “Layer 1 detected” notification of the target access point,
notification message forwarded to the serving RNC 305,
a handover complete message received at the target access point, and
a message forwarded to the serving RNC 305 indicating successful handover.

Any one or more of the above may trigger the informing of the assisting access point of the handover.

At step 403, the radio network controller may provide an indication to the access point providing the assisting cell that handover has occurred. The indication may be provided over an lub interface in some examples.

FIG. 5b shows the method steps carried out by an access point supporting an assisting cell for multi-flow communication. At step 405, the access point may receive an indication that handover has occurred for a user equipment for which it was providing multi-flow communication. In response to this indication, the access point may update a carrier activation status. In some embodiments, the carrier activation status may be updated to active. In some embodiments, the carrier activation status may be updated to be aligned with the carrier activation status of the user equipment after handover.

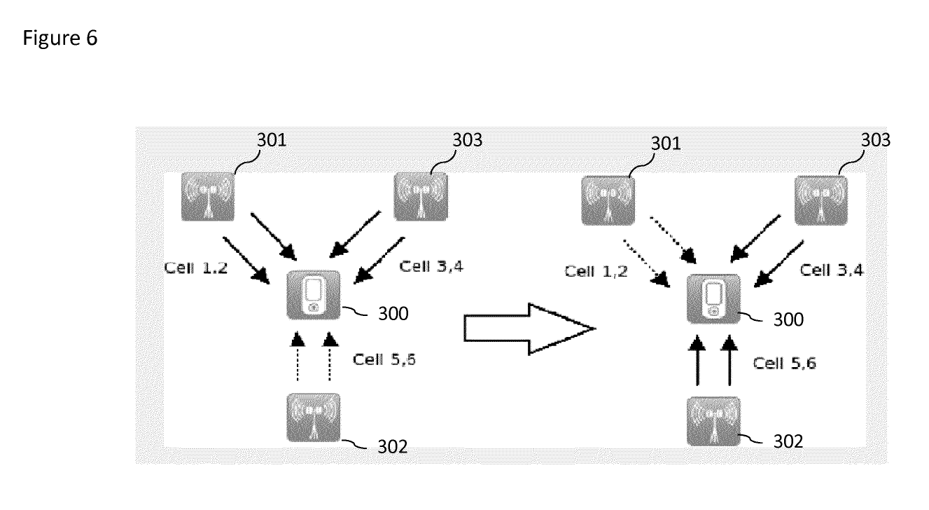

Reference is made to FIG. 6 which schematically shows on the right a UE 300 which is arranged to have cells 1 and 2 from a first access point 301 (serving cells) and cells 3 and 4 from a second access point 303 (assisting cells). The access points may be Node Bs. The UE due to the handover changes serving cells, whereas the assisting cells remain the same. This is shown on the left of FIG. 6. The UE 300 no longer has the cells from the first access point 301 but instead has the cells 5 and 6 from a third access point 302 (serving cells).

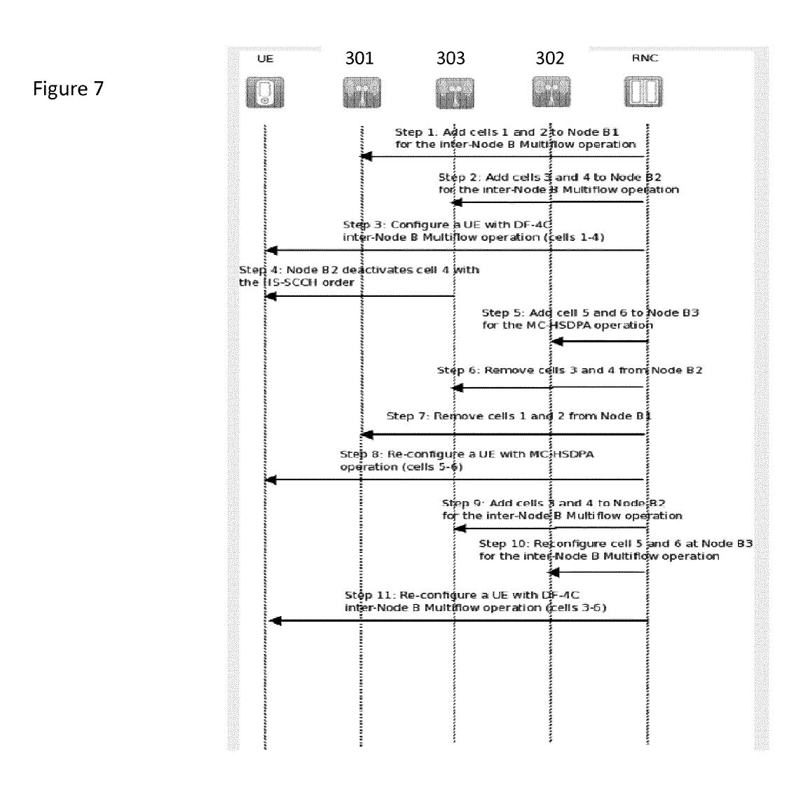

Reference is made to a first signal flow in FIG. 7 associated with the arrangement of FIG. 6 which shows an arrangement in which to avoid misaligned carrier activation status, the first multiflow needs to be deactivated (steps 6-8) and then activated (steps 9-11). This may cause unnecessary signalling.

In step 1, cells 1 and 2 are added to the first access point 301 for the inter-Node B multiflow operation. This is done via signalling from the RNC to the first access point 301.

In step 2, cells 2 and 3 are added to the second access point 303 for the inter-Node B multiflow operation. This is done via signalling from the RNC to the second access point 303.

In step 3, a UE is configured with an inter-Node B multiflow operation with four cells 1 to 4 on two frequencies. This is done via signalling from the RNC to the UE.

In step 4, the second access point 303 deactivates cell 4 with an HS-SCCH order. This is done via signalling from the second access point 303 to the UE.

In step 5, cells 5 and 6 are added to the third access point 302 for the MC-HSDPA (multicarrier HSDPA) operation. This is done via signalling from the RNC to the third access point 302.

In step 6, cells 3 and 4 are removed from the second node 303. This is done via signalling from the RNC to the second node 303.

In step 7, cells 1 and 2 are removed from the first node 301. This is done via signalling from the RNC to the first node 301.

In step 8, the UE is reconfigured with a MC-HSDPA operation. This is done via signalling from the RNC to the UE.

In step 9, cells 3 and 4 are added to the second node 303 for the inter-Node B multiflow operation. This is done via signalling from the RNC to the second node 303.

In step 10, cells 5 and 6 are reconfigured at the third access point 302 for the inter-Node B multiflow operation. This is done via signalling from the RNC to the third access point.

In step 11, UE is reconfigured with inter-Node B multiflow operation with four cells 3 to 6 on two frequencies. This is done via signalling from the RNC to the UE.

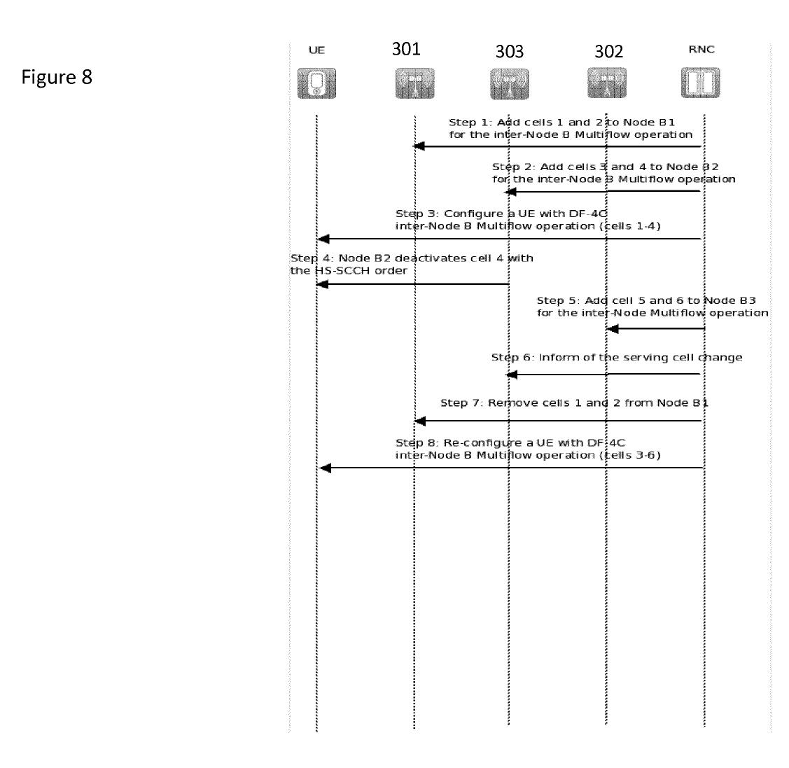

Reference is made to FIG. 8 which shows a signal flow of some embodiments where multiflow is not terminated upon handover.

In step 1, cells 1 and 2 are added to the first access point 301 for the inter-Node B multiflow operation. This is done via signalling from the RNC to the first access point 301.

In step 2, cells 2 and 3 are added to the second access point 303 for the inter-Node B multiflow operation. This is done via signalling from the RNC to the second access point 303.

In step 3, a UE is configured with inter-Node B multiflow operation with four cells 1 to 4 on two frequencies. This is done via signalling from the RNC to the UE.

In step 4, the second access point 303 deactivates cell 4 with an HS-SCCH order. This is done via signalling from the second access point 303 to the UE.

In step 5, cells 5 and 6 are added to the third access point 302 for the MC-HSDPA (multicarrier HSDPA) operation. This is done via signalling from the RNC to the third access point 302.

In step 6, the second node 303 is advised of the serving cell change. This is done via signalling from the RNC to the second node 303.

The RNC may be aware of the serving cell change if the RNC is associated with the serving cell which has changed and/or with the new serving cell. Alternatively the RNC may be aware of the serving cell change because of information received from another RNC. It should be appreciated that the RNC may alternatively be aware of the serving cell change in any other suitable way. It should be appreciated that any of the determining of handover may use any of the previously mentioned alternatives.

In step 7, cells 1 and 2 are removed from the first node 301. This is done via signalling from the RNC to the first node 301.

In step 8, UE is reconfigured with inter-Node B multiflow operation with four cells 3 to 6 on two frequencies. This is done via signalling from the RNC to the UE.

The arrangement of FIG. 8, in contrast to the arrangement of FIG. 7, does not steps 9-11 of FIG. 7 as there is a new multiflow configuration in steps 6-8. The assisting Node B does not require multiflow re-configuration.

Embodiments of the present disclosure may be implemented in systems that implement high speed packet access (HSPA). HSPA may be a mobile telephone protocol that can be implemented in mobile telecommunications networks that utilise wideband code division multiple access (WCDMA). One aspect of HSPA is the multi-carrier HSPA in which two or more carriers are aggregated to provide a high speed access. In multi-carrier HSPA secondary cells may be dynamically activated and/or deactivated from an access node using high speed shared control channel orders (HS-SCCH). Multi-flow in some networks may be functionally based on multi-carrier HSPA and in multi-flow HS-SCCH orders may be used by an access point to control and handle cells associated with that access point with respect to multi-flow operations. Embodiments may be implemented in systems using HSPA, for example the handover may be the handover of a high speed downlink shared channel (HS-DSCH).

In the case of inter-access point multi-flow as described with reference to FIGS. 4a and 4b, a serving cell and assisting cell are supported by access nodes and a serving access node cannot control the assisting cell provided by an assisting access node. With reference to FIGS. 4a and 4b, in embodiments an indication of handover is provided to an assisting access node from its supporting radio network controller. If the serving and assisting access points are supported by different radio network controllers, an additional indication of handover may be provided to the radio network controller supporting the assisting access point from the radio network controller supporting the serving access point. In some examples, this indication may be sent as part of a HS-SCCH order.

In embodiments of the present disclosure, an indication may be provided over the lub (interface between a radio network controller and an access point) and optionally an lur (interface between radio network controllers). In an example, the indication may be provided as a separate container information element (IE) carrying multi-flow specific configuration.

This handover indication is carried from RNC to the Node B (lub), or RNC via another RNC (lur) to the Node B (lub), whereas the HS-SCCH order is then sent by the Node B to the UE. The container is a super-structure in the NBAP/RNSAP protocols (used over the lub/lur interfaces), each container consists of a group of information elements, such as shown in the table below.

Table 1 gives an example of such a container comprising the IE containing the indication. This may be sent from the RNC to the assisting Node B.

| | | | | | | |
|---|---|---|---|---|---|---|
| | | | IE Type and | Semantics | | Assigned |
| IE/Group Name | Presence | Range | Reference | Description | Criticality | Criticality |

| | | | | |
|---|---|---|---|---|
| Total number of HS-DSCH | M | INTEGER | Total number of | — |
| cells | | (2 . . . 32, . . . ) | HS-DSCH cells | |
| | | | configured for | |
| | | | Multiflow. | |
| Role | M | Multiflow Role | | — |
| | | 9.2.2.173 | | |
| MIMO | M | Multiflow | | — |
| | | MIMO | | |
| | | 9.2.2.174 | | |
| Timing | O | Multiflow | In the inter-Node | — |
| | | Timing | B Multiflow case, if | |
| | | 9.2.2.175 | present, this IE | |
| | | | provides the | |
| | | | timing information. | |
| Max number of HS-SCCH | O | INTEGER | Maximum number | — |
| sets per Node B | | (1 . . . 16, . . .) | of HS-SCCH that | |
| | | | can be allocated | |
| | | | per NodeB. | |
| HS-DSCH serving cell | O | BOOLEAN | In the inter-Node | |
| changed | | | B case, this IE | |
| | | | indicates to the | |
| | | | assisting Node B | |
| | | | that the serving | |
| | | | Node B changed - | |
| | | | this is sent from | |
| | | | the RNC to the | |
| | | | assisting Node B | |
| | | | in some | |
| | | | embodiments. | |

It will be appreciated that Table 1 is by way of example only. For example, while the example of Table 1 contains only an indication of a handover occurring, the IE may be expanded to explicitly indicate the changed serving cell. In some examples the indicator may be a Boolean value or may, for example, include more detailed information about the serving cell change for example and/or the identity of the source cell, the target cell and/or the change time and/or alignment action to perform at assisting access node.

It will be appreciated that on receipt of such an indication a user equipment may update a carrier activation status to reflect the handover of the user equipment. It will be appreciated that the IE may be transmitted from the radio network controller supporting the serving access point to the radio network controller supporting the assisting access point and/or from the radio network controller supporting the assisting access point to the assisting access point.

In the above embodiments, reference has been made to the handover of a user equipment from one or more cells to one or more other cells. It should be appreciated that in other embodiments, there may be a change from one cell to another cell.

In some embodiments, the serving cell of a UE may change from one cell to another cell which is already a cell with which the UE is in communication. That cell would change status to be a serving cell.

It will be appreciated that in the foregoing a user equipment has been described. A user equipment may be any suitable communication device. In particular, the communication devices 102, 103, 104 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Access points of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by access points of systems that are based on technologies such as wireless local area network (WLAN) and/or WiMax (Worldwide Interoperability for Microwave Access).

An appropriately adapted computer program code product or products may be used for implementing the embodiments, when loaded on an appropriate data processing apparatus. The program code product for providing the operation may be stored on, provided and embodied by means of an appropriate carrier medium.

An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

Some aspects of the embodiments may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It is also noted herein that while the above describes exemplifying embodiments of the invention, there are several variations and modifications which may be made to the disclosed solution without departing from the scope of the present invention.

1. A method comprising:
determining that a handover of a user equipment in multi-flow communication with a serving cell and an assisting cell has taken place; and
providing, from a radio network controller to a first access point providing the assisting cell, an indication of the handover.

2. The method of claim 1 wherein the radio network controller receives an indication of the handover from a radio network controller of an access point supporting the serving cell.

3. The method of claim 1, wherein the radio network controller supports the first access point and a second access point providing the serving cell.

4. The method of claim 1, wherein the determination is based on the radio network controller carrying out a handover procedure for the user equipment.

5. A method comprising:
providing an assisting cell in a multi-flow communication with a user equipment;
receiving, from a radio network controller, an indication of a handover of the user equipment in communication with a serving cell and the assisting cell; and
updating a carrier activation status of the assisting cell.

6. The method of claim 5 wherein the carrier activation status is updated to active.

7. The method of claim 5, wherein the carrier activation status is updated to be aligned with a carrier activation status of the user equipment.

8. The method as claimed in claim 1, wherein said handover is such that the serving cell of said user equipment is changed.

9. The method as claimed in claim 1, wherein the handover is between the serving cell and a target cell.

10. The method of claim 1, wherein the indication forms part of an information element.

11. The method of claim 10, wherein said information element comprises at least one of multi-flow configuration information and configuration information.

12. The method of claim 1, wherein the indication includes an indication of at least one of the target cell and the serving cell.

13. Apparatus for use in a radio network controller, said apparatus comprising at least one processor and at least one memory including computer code for one or more programs, the at least one memory and the computer code configured, with the at least one processor, to cause the apparatus at least to:
determine that a handover of a user equipment in multi-flow communication with a serving cell and an assisting cell has taken place; and
provide, to a first access point providing the assisting cell, an indication of the handover.

14. The apparatus of claim 13, wherein the radio network controller receives an indication of the handover from a radio network controller of an access point supporting the serving cell.

15. The apparatus of claim 13, wherein the radio network controller supports the first access point and a second access point providing the serving cell.

16. The apparatus of claim 13, wherein the determination is based on the radio network controller carrying out a handover procedure for the user equipment.

17.-19. (canceled)

20. The apparatus as claimed in claim 13, wherein said handover is such that the serving cell of said user equipment is changed.

21. The apparatus as claimed in claim 13, wherein the handover is between the serving cell and a target cell.

22. The apparatus as claimed in claim 13, wherein the indication forms part of an information element.

23. (canceled)

24. The apparatus as claimed in claim 13, wherein the indication includes an indication of at least one of the target cell and the serving cell.

25. (canceled)
